(19) United States
(12) Patent Application Publication
(10) Pub. No.: US 2018/0170275 A1
(43) Pub. Date: Jun. 21, 2018

(54) MULTIPLE TEMPERATURE SENSOR CAR RADIO INSTALLATION KIT

(71) Applicant: AAMP of Florida, Inc., Clearwater, FL (US)

(72) Inventors: Brett D. Riggs, Yorba Linda, CA (US); Nathaniel Lee Wincek, New Port Richey, FL (US)

(21) Appl. No.: 15/384,390

(22) Filed: Dec. 20, 2016

(51) Int. Cl. B60R 11/02; B60H 1/00; B60K 37/02

(52) U.S. Cl. CPC B60R 11/0211; B60H 1/00642; B60R 2011/0005; B60R 11/0235; B60R 11/0258; B60K 37/02

(57) ABSTRACT

Embodiments of the proposed invention preferably provide systems and methods for an improved aftermarket car radio installation kit that integrates with, improves on, and adds to OEM climate control functionality.

### FIELD OF TECHNOLOGY

Aspects of the invention relate to a car radio installation kit for enabling installation of an aftermarket stereo unit in a vehicle.

### BACKGROUND

Today most vehicles are built by an original equipment manufacturer (“OEM”) with pre-installed audio and entertainment systems. However, for some customers the pre-installed audio systems do not offer the quality or features desired. For example, some enthusiasts may desire higher performing audio systems. To obtain the features and performance they desire, customers may turn to aftermarket manufacturers of audio equipment.

The aftermarket manufacturers supply audio products such as stereo systems (referred to commonly, and, in the alternative herein, as “car radios” or “head units.”) These head units may be used to replace the vehicle's OEM stereo system. A head unit is a component of vehicle audio system that provides an occupant interface for adjusting components of a vehicle's audio system. For example, the head unit may include controls for adjusting audio settings such as volume, tuning the radio, and bass or treble levels. Through continued advances in automotive technology, climate controls have, in certain vehicles, been incorporated into certain aftermarket head units.

A challenge facing aftermarket manufacturers is to ensure that later-added equipment does not interfere with pre-installed OEM features of a vehicle. For example, when some OEM climate controls are implemented in conjunction with the OEM radio and/or stereo, care must be taken to preserve the operational integrity of OEM climate controls.

Some pre-installed OEM features also relate to steering wheel controls on a vehicle. Such steering wheel controls may be used to operate the head unit. It is important to maintain the operational integrity of such steering wheel controls following replacement of the OEM head unit with an aftermarket head unit. Patents that deal with the maintaining of such steering wheel controls include U.S. Provisional Patent Application No. 60/108,711 and U.S. Pat. Nos. 6,956,952, 7,020,289, 7,613,308, 7,684,570, 8,015,540, 8,184,825, 8,284,950 and 9,165,593—each of which is incorporated by reference herein in its respective entirety.

A further challenge facing both OEM and aftermarket manufacturers is, inter alia, integrating climate control features into an aftermarket system. For example, one may wish to integrate climate control features into an aftermarket audio system in order to replace climate control features resident in an OEM system. Integration of additional features may involve the coordination of different audio system components.

Accordingly, there is a need for an improved aftermarket car radio installation kit that, inter alia, integrates desired climate control features of an OEM system.

Further, there is a need for introducing new climate control features using an aftermarket car radio installation kit.

### SUMMARY OF THE DISCLOSURE

It is an object of this disclosure to provide an improved aftermarket car radio installation kit that integrates, inter alia, desired climate control features of an OEM system into an aftermarket kit.

Further, there is a need for introducing, inter alia, new climate control features using an aftermarket kit.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a schematic of a conventional circuit for use in a car radio installation kit;

FIG. 2 shows a schematic of an embodiment of a circuit for use in a car radio installation kit according to certain embodiments; and

FIG. 3 shows an elevational view of a kit according to certain embodiments;

FIG. 4 shows an exploded view of a kit according to certain embodiments;

FIG. 5 shows a front view of a kit according to certain embodiments; and

FIG. 5A shows an enlarged cut-out portion of FIG. 5.

### DETAILED DESCRIPTION OF THE DISCLOSURE

Apparatus and methods for providing an aftermarket car radio installation kit are provided. The amplifier is preferably easy to install and integrates, improves upon, and, in certain embodiments, adds additional functionality to legacy OEM functionality of the automobile.

Embodiments include an aftermarket car radio installation kit that may be used to introduce, inter alia, new climate control features to an automobile while preserving various OEM features and integrating with other OEM features.

Embodiments of the aftermarket car radio installation kit may be powered-on by detection of an authorized vehicle ignition implement. Embodiments may be powered-on by detection of data activity on the system data bus.

Additionally, embodiments may maintain the preexisting vehicle functionality for use with the aftermarket head unit. For example, if the OEM head unit was adapted to respond to steering wheel controls, then the embodiments of the radio installation kit may preferably maintain the steering wheel controls as operationally coupled to the aftermarket head unit for controlling the aftermarket head unit in substantially the same way that the steering wheel controls controlled the OEM head unit.

Furthermore, features, such as, for example, climate control features, may be improved without complex rewiring. For example, buttons that are typically found on the steering wheel correspond to audio and/or Bluetooth controls. These buttons are the input devices for steering wheel control of the car stereo. In certain embodiments, these buttons may be remapped for other purposes. In some embodiments, the buttons that are found on the steering wheel and that correspond to audio and/or Bluetooth controls may be remapped to control climate controls generally located within the automobile, or specifically located within the kit.

Improvements over OEM functionality may include integrating one, two (“dual”) or even more temperature sensors into the car stereo installation kit. Such a kit may be configured for installation in a vehicle that previously only contained a single temperature sensor. In such embodiments, the multiple temperature sensors may accomplish at least two tasks.

First, the multiple temperature sensors may replace the OEM temperature sensor as the information source for automobile climate information. Such sensors may provide updates from one or more locations within the automobile. Such locations may preferably substantially correspond to the current climate conditions—e.g., temperature—at several locations within the automobile. Such an arrangement may preferably include a customized location of the temperature sensors. Customized location of the temperature sensors may improve flexibility of climate control within the automobile.

It should be noted that one advantage of the multiple sensors is that, when the information from each of the multiple sensors is taken together, the information from the multiple sensors may preferably provide a more diversified and complete data set reflective of the temperature within an automobile. As such, the diversified data set may be more useful to control climate within an automobile because the chances of the data set getting skewed by anomalous temperature conditions in one portion of the automobile will be reduced by the additional data points received from the more than one temperature sensor.

Second, the temperature sensors located within the kit may expand the number of temperature zones controlled by the climate controls of the automobile. Accordingly, such temperature sensors may improve the accuracy and granularity of climate control within the vehicle.

In certain embodiments, other functionality may be added to the car stereo installation kit. For example, an automatic air quality sensor may be added to the kit. In such embodiments, the air quality sensor located in the kit may be configured to determine whether the air in the automobile should be continually drawn from outside the automobile or the air within the automobile should be recirculated in order to avoid drawing additional, and, possibly, inferior quality, air from outside the vehicle. Such a feature may preferably enable a climate control system to test the most relevant air—i.e., the air in the cabin—relative to air drawn from outside the vehicle into the cabin in order to determine whether the cabin air is of superior quality to the air drawn from outside the vehicle.

Other possible functionality that may be incorporated into a car radio installation kit may include one or more infrared temperature sensors. Such an infrared (“IR”) temperature sensor may include one or more movable temperature sensors. For example, such an IR temperature sensor may be configured to poll a set of different locations within the automobile to determine the temperature of various locations within the automobile.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

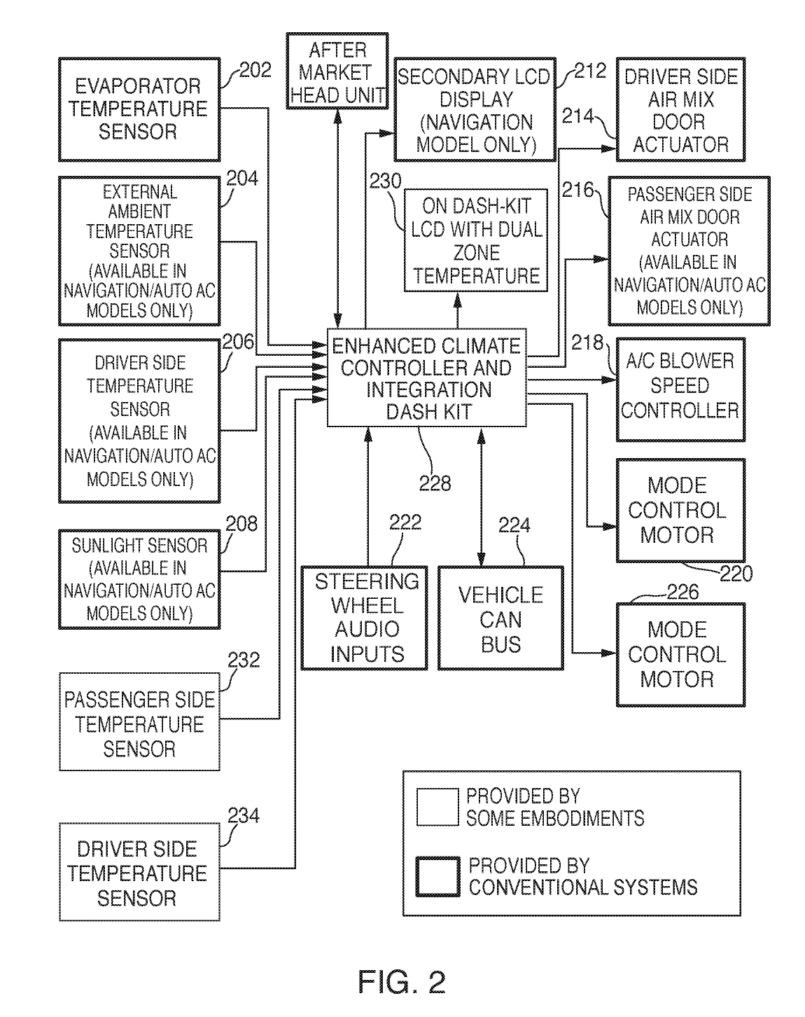

Processes in accordance with the principles of the invention may include one or more features of a “system.” The “system” may include one or more of the features of the apparatus that are shown in FIG. 2 and/or any other suitable device or approach. The “system” may be provided by an entity. The entity may be an individual, an organization or any other suitable entity.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like. In a distributed computing environment, devices that perform the same or similar function may be viewed as being part of a “module” even if the devices are separate (whether local or remote) from each other.

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network. In a distributed computing environment, program modules may be located in both local and remote computer storage media including memory storage devices.

Certain embodiments of an aftermarket car radio installation kit may include one or more temperature sensor(s) mounted within the kit. The kit may be configured to detect, using at least one of the one or more temperature sensor(s), a first temperature from a first location in an automobile interior. The kit may also be configured to detect, using at least one of the one or more temperature sensor(s), a second temperature from a second location in the automobile interior. The second location may preferably be different from the first location.

The kit may also include a microcontroller configured to receive the first temperature and the second temperature. In response to receiving the first temperature and the second temperature, the microcontroller may be configured to generate a temperature control output that controls the temperature in the first location based on the first temperature and that controls the temperature in the second location based on the second temperature.

One or more of the temperature sensor(s) that may be used to detect the first temperature or the second temperature may be an infrared temperature sensor. One or more of the temperature sensor(s) that may be used to detect the first temperature or the second temperature may be a thermocouple.

In certain embodiments, the kit may be further configured to receive climate control signals from steering wheel controls. The steering wheel controls from which the kit is receiving the climate controls may be steering wheel controls that were originally purposed for controlling audio functions. Such steering controls may, under certain conditions or configurations, such as in response to manual remapping by an end user, may be remapped to control climate controls.

In certain embodiments, remapping may be accomplished by depressing a selected key for a pre-determined amount of time. For example, volume up/volume down controls located on the steering wheel controls may be remapped to become temperature up/temperature down controls by holding the mute button down for a pre-determined amount of time, such as 3 seconds. Other combinations of such remapping are also within the disclosure of the present patent application.

In some embodiments, one or more temperature sensor(s) that may be used to detect the first temperature may be the same sensor as used to detect the second temperature. In certain embodiments, the one or more temperature sensor(s) that may be used to detect the first temperature may be different from the one or more temperature sensor(s) used to detect the second temperature.

Certain embodiments may include an aftermarket car radio installation kit that includes a first temperature sensor configured to detect a first temperature from a first location in an automobile interior and a second temperature sensor configured to detect a second temperature from a second location in the automobile interior. The second location may be different from the first location. The kit may also include a microprocessor configured to generate a temperature control output based on the first temperature and the second temperature.

The first temperature sensor and the second temperature may be the same temperature sensor or may be different temperature sensors.

Certain embodiments of the invention may also include other sensors such as moisture sensors, odor sensors, sunlight sensors and substantially any other suitable sensors. In some embodiments, glass located in certain areas may be electrochromic or photochromic. Switchable automotive window film, such as film manufactured by Glass Apps™ and sold under the trade name SuperClear switchable privacy window film, may also be used in some embodiments. Such embodiments may include a method such as detecting, using one more sensors, sunlight or high temperature in a certain area of the automobile and, in response to the detection, triggering a switchable window film that preferably eliminates almost all of the UV rays from a designated area and some, if not most, of the heat-producing sunlight. In certain embodiments, the triggering of the film may be in response to a manual signal.

In certain embodiments, the first temperature and the second temperature sensor may be the same temperature sensor which, in turn, may be an infrared temperature sensor. In such embodiments, the kit may further comprise an actuator for changing the sensing orientation of the infrared temperature sensor. Accordingly, when the infrared temperature sensor is oriented in the first direction, the temperature sensor is configured to sense the first temperature, and, when the same temperature sensor is oriented in the second direction, the temperature sensor is configured to sense the second temperature.

In some embodiments, the kit may be further configured to receive signals from steering wheel controls. The steering wheel controls may have been originally purposed for controlling audio functions but may have later been remapped for controlling climate control output functions.

The following disclosure preferably describes how the steering wheel controls may be remapped to operate the vehicle climate control system.

The OEM steering wheel controls are typically initially configured to enable control of the OEM radio and other audio functions. With an aftermarket radio replacement unit and a kit according to certain embodiments of the invention, the original steering wheel controls may be remapped to operate the aftermarket radio audio functions and operate some or all of the functions of the vehicle's climate control system.

One button on the factory steering wheel controls can be used to “select” the device that will be controlled—either the aftermarket radio or the vehicle climate control system.

One embodiment may include configured, during installation, the steering wheel controls to control the vehicle climate control system. During installation, one button on the steering wheel may be selected to be the alternate function button. When this selected button is pressed and held for some suitable period of time—e.g., two seconds—the display on the new aftermarket radio replacement kit may flash “temperature.” This flashing temperature may indicate that the steering wheel controls may now be used control the vehicle climate control functions. In order to return the steering wheel controls to the configuration in which the controls control the audio functions, the selected button may again be pressed and held for the suitable period of time until the display on the new aftermarket radio replacement kit may flash “audio.” In some embodiments, if no buttons are pressed for 7 seconds, the steering wheel button control will automatically revert back to controlling the new radio audio function when buttons are pressed.

In some embodiments, volume buttons on the steering wheel controls may be used to control temperature up and down functions. The steering wheel tune buttons may be used to control the fan speed up and down. Any suitable mapping of the steering wheel buttons for use with the vehicle climate control system may preferably be considered to be within the scope of the present invention.

The remapping capability of the steering wheel control buttons may preferably be implemented because of the following principles of operation of the interface between the steering wheel control buttons and the aftermarket radio. The interface may be programmed to store the selected “alternate” select button value.

In normal operation, if the interface receives this learned value of the alternate button for less than two seconds (or some other suitable time period) the interface will control the aftermarket radio's intended audio function. If the interface receives the learned value of the alternate button for more than two seconds (or some other suitable time period), the steering wheel controls operate the vehicle climate control functions. In such a scenario, volume buttons perform temperature up and down and the radio tune bottoms change the fan speed up and down.

Some embodiments of the invention may include an aftermarket car radio installation kit that includes a moveable temperature sensor mounted within the aftermarket car radio installation kit. The moveable temperature sensor may be configured to be oriented in several different positions.

In a first position, the moveable temperature sensor may be configured to detect a first temperature from a first location in an automobile interior. In a second position, the moveable temperature sensor may be configured to detect a second temperature from a second location in the automobile interior. The second location may be different from the first location.

In some embodiments, the kit may further include a microprocessor configured to receive the first temperature and the second temperature. The microprocessor may be further configured to generate a temperature control output to at least two zones of the automobile interior. The microprocessor may be further configured to generate a temperature control output to a first zone in the automobile based on the first temperature. The microprocessor may be yet further configured to generate a second control output to a second zone in the automobile based on the second temperature.

In such embodiments, the temperature sensor may be an infrared temperature sensor. In such embodiments, the temperature sensor may be a thermocouple.

In some embodiments, the kit may include an actuator for changing the sensing orientation of the temperature sensor. Such an actuator may operate as follows. When the temperature sensor is oriented in the first direction, the temperature sensor may be configured to sense the first temperature. When the temperature sensor is oriented in the second direction, the temperature sensor may be configured to sense the second temperature.

In certain embodiments, the temperature sensor may be configured to poll one or more locations proximal the first location in order to sense the first temperature. In some embodiments, the temperature sensor may be configured to poll one or more locations proximal the second location in order to sense the second temperature.

An aftermarket car stereo installation kit, according to certain embodiments, may monitor temperature at a plurality of locations within in a vehicle. In certain embodiments, the kit may send at least one climate control signal via an automobile data bus. The climate control signal may be configured to adjust climate at at least one location within the vehicle, such adjusting may be based on the monitored temperature at a plurality of locations within the vehicle.

Certain embodiments may include one or more methods for using an aftermarket car radio installation kit within an automobile. The aftermarket car audio installation kit may include a first temperature sensor, a second temperature sensor and a microcontroller.

Such embodiments of the method may include detecting, using the first temperature sensor, a first temperature from a first location in an automobile interior. Such methods may further include detecting, using the first temperature sensor, or, alternatively, second temperature sensor, a second temperature from a second location in the automobile interior. The second location may be different from the first location. In addition, such methods may include receiving, at a microcontroller, the first temperature and the second temperature.

In response to receiving the first temperature and the second temperature, some embodiments of methods may include using the microcontroller to generate a temperature control output that is configured to induce a change in the temperature in the first location based on the first temperature and that is configured to induce a change in the temperature in the second location based on the second temperature.

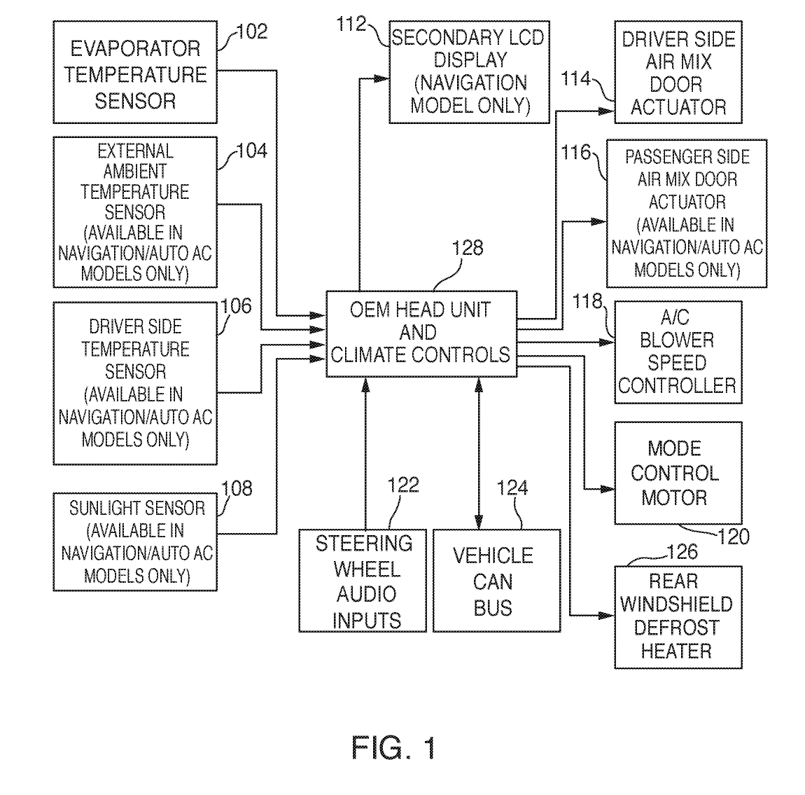

FIG. 1 shows a prior art OEM automobile electronic climate control system architecture 100. Architecture 100 includes a group of climate sensors 102-108. Sensors 102-108 may include an evaporator temperature sensor 102, an external ambient temperature sensor 104, a driver side temperature sensor 106 and sunlight sensor 108. It should be noted that external ambient temperature sensor 104, driver side temperature sensor 106 and sunlight sensor 108 may be optional sensors and may only be available in certain automobile models and/or classes of models. For example, the external ambient temperature sensor 104, driver side temperature sensor 106 and sunlight sensor 108 may only be available in navigation/automatic AC vehicle models.

Sensors 102-108 may preferably provide climate information to OEM head unit and climate controls 128. OEM head unit and climate controls 128 may be configured to receive additional inputs from steering wheel control inputs 122 and vehicle Controller Area Network (CAN) bus 124.

OEM head unit and climate controls 128 may also be configured to output climate control information preferably based, at least in part, on the climate information, to a number of locations. OEM head unit and climate controls 128 may be configured to provide information to the vehicle CAN bus 124. OEM head unit and climate controls 128 may be configured to output information to the secondary LCD display 112, which may also only be available on certain vehicle models.

OEM head unit and climate controls 128 may also be configured to output climate control information to climate control devices 114-126. Climate control devices 114-126 may include, inter alia, driver side air mix door actuator 114, passenger side air mix door actuator 116 (which may only be available on certain vehicle models), A/C blower speed controller 118, mode control motor 120 and rear windshield defrost heater 126.

FIG. 2 shows an automobile electronic climate control system architecture 200 according to certain embodiments of the invention. In FIG. 2, the elements that correspond to prior art elements shown in FIG. 1 are enclosed in a box that includes a bolded outline. The remaining, non-bolded, elements correspond to elements that may form part of an automobile electronic climate control system architecture according to certain embodiments of the invention. The bolded elements that correspond to prior art elements include elements 202, 204, 206, 208, 212, 214, 216, 218, 220, 222, 224 and 226.

Passenger side temperature sensor 232 forms part of an automobile electronic climate control system architecture 200 according to certain embodiments. A driver side temperature sensor 234 may be included in addition to sensor 206, replace sensor 206 or provide functionality not found in sensor 206.

After market head unit 225 may also form part of embodiments of the invention or may be separate therefrom. Climate controller and integration dash kit 228 may preferably have been reconfigured to provide functionality that corresponds to the additional sensor input provided by passenger side temperature sensor 232 and/or driver side sensor 234. Such functionality included in climate controller and integration dash kit 228 may include functionality that administers multiple temperature sensor functionality to a vehicle. For example, the multiple sensor functionality may enable a user in a first zone to control the climate relevant to the first zone and enable a user in a second zone to control the climate relevant to the second zone. Such zonal control of temperature, which may be responsive to sensor information in the first and sensor information in the second zone, may preferably control the temperature in each zone such that the temperature control in each zone is independent of one another.

On dash-kit LCD with dual zone temperature 230 may also form part of embodiments of the invention.

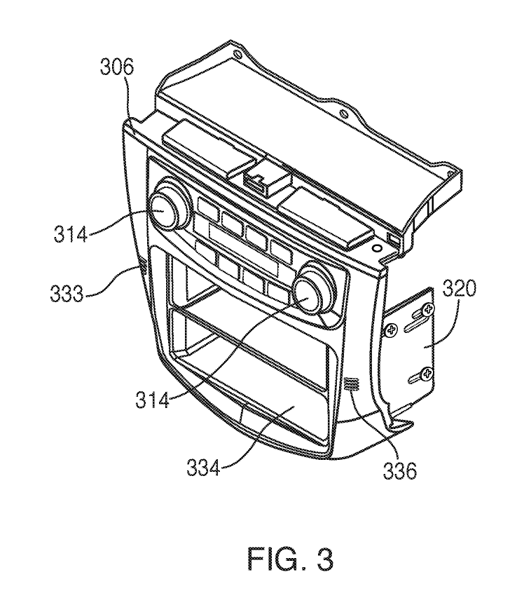

FIG. 3 shows an elevational view of a kit according to certain embodiments. FIG. 3 includes, inter alia, OEM navigation replacement adaptor 306, rotary knobs 314, bracket 320, ISO pocket 334, passenger side temperature sensor vent 336 and driver side temperature sensor vent 338.

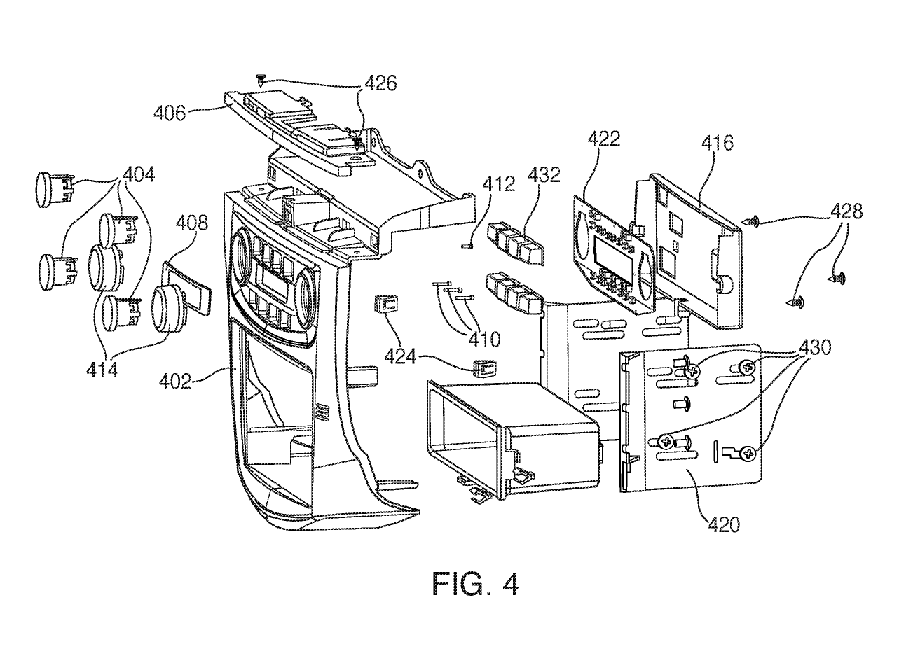

FIG. 4 shows an exploded view of a kit according to certain embodiments. The kit shown in FIG. 4 preferably includes kit main frame 402, center knob buttons 404, OEM navigation replacement adaptor 406, LCD lens 408, lightpipe bottom 410, lightpipe top 412, rotary knobs 414, back cover 416, left side bracket 418, right side bracket 420, rubber membrane 422, trim clip fastener 424, screw(s) 426, screw(s) 428, large diameter head screw 430, hard buttons 432, ISO pocket 434, passenger side temperature sensor vent 436 and driver side temperature sensor vent 438.

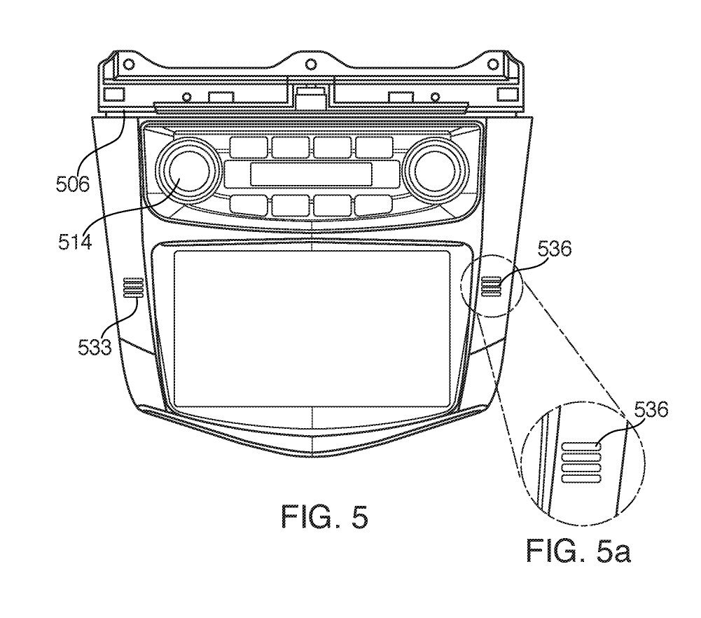

FIG. 5 shows a front view of a kit according to certain embodiments. FIG. 5 includes, inter alia, OEM navigation replacement adaptor 506, rotary knobs 514, passenger side temperature sensor vent 536 and driver side temperature sensor vent 538.

FIG. 5A shows an enlarged cut-out portion of FIG. 5. Specifically, FIG. 5A shows an enlarged view of the portion of the kit that includes passenger side temperature sensor vent 536.

Thus, systems and methods for providing an improved aftermarket car radio installation kit that is easy to install and integrates with, improves on, and adds to, OEM functionality have been provided. Persons skilled in the art will appreciate that the present invention can be practiced by other than the described embodiments, which are presented for purposes of illustration rather than of limitation. The present invention is limited only by the claims that follow.

What is claimed is:

1. An aftermarket car radio installation kit, said aftermarket car radio installation kit comprising:
one or more temperature sensor(s) mounted within the kit, the kit configured to:
detect, using at least one of the one or more temperature sensor(s), a first temperature from a first location in an automobile interior;
detect, using at least one of the one or more temperature sensor(s), a second temperature from a second location in the automobile interior, said second location being different from the first location; and
a microcontroller configured to receive the first temperature and the second temperature and, in response to receiving the first temperature and the second temperature, generate a temperature control output that controls the temperature in the first location based on the first temperature and that controls the temperature in the second location based on the second temperature.

2. The kit of claim 1, wherein the one or more temperature sensor(s) used to detect the first temperature is an infrared temperature sensor.

3. The kit of claim 1, wherein the one or more temperature sensor(s) used to detect the first temperature is a thermocouple.

4. The kit of claim 1 wherein the one or more temperature sensor(s) used to detect the second temperature is an infrared temperature sensor.

5. The kit of claim 1 wherein the one or more temperature sensor(s) used to detect the second temperature is a thermocouple.

6. The kit of claim 1 wherein the kit is further configured to receive signals from steering wheel controls, said steering wheel controls that were originally purposed for controlling audio functions.

7. The kit of claim 1, wherein the one or more temperature sensor(s) used to detect the first temperature and the one or more temperature sensor(s) used to detect the second temperature is the same temperature sensor.

8. The kit of claim 1, wherein the temperature sensor used to detect the first temperature and the temperature sensor used to detect the second temperature are different temperature sensors from one another.

9. An aftermarket car radio installation kit comprising:
a first temperature sensor, said first temperature sensor configured to detect a first temperature from a first location in an automobile interior;
a second temperature sensor, said second temperature sensor configured to detect a second temperature from a second location in the automobile interior, said second location being different from the first location; and
a microprocessor configured to generate a temperature control output based on the first temperature and the second temperature.

10. The kit of claim 9, wherein the first temperature sensor and the second temperature are the same temperature sensor.

11. The kit of claim 10, wherein the same temperature sensor is an infrared temperature sensor.

12. The kit of claim 11, further comprising an actuator for changing the sensing orientation of the temperature sensor such that, when the same temperature sensor is oriented in the first direction, the temperature sensor is configured to sense the first temperature, and, when the same temperature sensor is oriented in the second direction, the temperature sensor is configured to sense the second temperature.

13. The kit of claim 9, wherein the first temperature sensor and the second temperature are different temperature sensors.

14. The kit of claim 9 wherein the kit is further configured to receive signals from steering wheel controls, said steering wheel controls that were initially only purposed for controlling audio functions.

15. An aftermarket car radio installation kit comprising:
a moveable temperature sensor mounted within the aftermarket car radio installation kit, said temperature sensor configured, in a first position, to detect a first temperature from a first location in an automobile interior, and configured, in a second position, to detect a second temperature from a second location in the automobile interior, said second location being different from the first location; and
a microprocessor, said microprocessor configured to receive the first temperature and the second temperature, and further configured to generate a temperature control output to at least two zones of the automobile interior based on the first temperature and the second temperature.

16. The kit of claim 15, wherein the temperature sensor is an infrared temperature sensor.

17. The kit of claim 15, further comprising an actuator for changing the sensing orientation of the temperature sensor such that, when the same temperature sensor is oriented in the first direction, the temperature sensor is configured to sense the first temperature, and, when the same temperature sensor is oriented in the second direction, the temperature sensor is configured to sense the second temperature.

18. The kit of claim 15, wherein, the temperature sensor is configured to poll one or more locations proximal the first location in order to sense the first temperature and to poll one or more locations proximal the second location in order to sense the second temperature.

19. A method for using an aftermarket car radio installation kit within an automobile, said aftermarket car audio installation kit comprising a first temperature sensor, a second temperature sensor and a microcontroller, the method comprising:
detecting, using the first temperature sensor, a first temperature from a first location in an automobile interior;
detecting, using the second temperature sensor, a second temperature from a second location in the automobile interior, said second location being different from the first location; and
receiving, at a microcontroller, the first temperature and the second temperature and, in response to receiving the first temperature and the second temperature, using the microcontroller to generate a temperature control output that is configured to induce a change in the temperature in the first location based on the first temperature and that is configured to induce a change in the temperature in the second location based on the second temperature.

20. An aftermarket car radio installation kit, said aftermarket car radio installation kit comprising:
one or more independent temperature sensor(s) for mounting in a vehicle remote from the aftermarket car radio, the kit configured to:
detect, using at least one of the one or more independent temperature sensor(s), a first temperature from a first location in an automobile interior;
detect, using at least one of the one or more independent temperature sensor(s), a second temperature from a second location in the automobile interior, said second location being different from the first location; and
a microcontroller configured to receive the first temperature and the second temperature and, in response to receiving the first temperature and the second temperature, generate a temperature control output that controls the temperature in the first location based on the first temperature and that controls the temperature in the second location based on the second temperature.
